(19) United States
(12) Patent Application Publication
(10) Pub. No.: US 2017/0184390 A1
(43) Pub. Date: Jun. 29, 2017

(54) SYSTEM FOR DETECTING DEFORMATION OF CUSHION PAD AND PRODUCTION THEREOF

(71) Applicant: TOYO TIRE & RUBBER CO., LTD., Osaka-shi, Osaka (JP)

(72) Inventors: Takeshi Fukuda, Osaka-shi (JP); Takahiro Ohta, Osaka-shi (JP)

(73) Assignee: TOYO TIRE & RUBBER CO., LTD., Osaka-shi, Osaka (JP)

(21) Appl. No.: 15/322,801

(22) PCT Filed: Jun. 15, 2015
(86) PCT No.: PCT/JP2015/067214

§ 371 Date: Dec. 29, 2016

(30) Foreign Application Priority Data
Jul. 3, 2014 (JP) 2014-138052

(51) Int. Cl. G01B 7/24; B60N 2/44

(52) U.S. Cl. CPC G01B 7/24; B60N 2/44; A47C 7/18

(57) ABSTRACT

The present invention provides a cushion pad with improved durability without feeling of a foreign object.

The present invention thus provides a system for detecting a deformation of a cushion pad, comprising;
the cushion pad comprising a matrix layer, in which electroconductive or magnetic filler is dispersed, and a soft polyurethane foam including the matrix layer incorporated therein, and
a detecting portion that detects an electric or magnetic change caused by a deformation of the cushion pad,
wherein the matrix layer has a hardness lower than the soft polyurethane, and it production method.

### TECHNICAL FIELD

The present invention is related to a system for detecting deformation of a cushion pad, in particular a system for detecting whether a person sits on a cushion pad used for a car seat, and a production method thereof.

### BACKGROUND ART

There has been practically used a warning system which detects whether a person sits on a seat in a vehicle, such as an automobile and then alerts if the person does not couple a seat belt. The warning system generally gives off an alert when it detects the sitting of the person and simultaneously detects not coupling the seat belt. The apparatus generally comprises a sitting sensor which detects whether a person is sitting on a seat and a sensor which detects not coupling the seat belt with a buckle although the person is seated, which gives off an alert when the uncoupling of the seat belt is detected. The sitting sensor necessitates high durability because it must detect a person sitting down many times. It is also necessary that, when a person is seated, the person does not feel the sensation of any foreign object in the seat.

JP 2012-108113 A (Patent Literature 1) discloses a sitting sensor equipped in a seat, detecting the sitting of a person, which comprises electrodes facing with each other in a cushion material and detects an electric contact of the electrodes. This sensor employs an electrode and should equip wiring. The wiring can be disconnected by receiving a large displacement and gives some problems in durability. In addition, the electrode is generally made of metallic substance which may create a sensation of a foreign object, when the person sitting. Even if the electrode is not metallic, the feeling of a foreign object would easily generate from the other substances.

JP 2011-255743 A (Patent Literature 2) discloses an electrostatic capacitance-type sitting sensor which comprises sensor electrodes facing with each other, between which dielectric substance is inserted, and an electrostatic capacitance-type sensor that measures an electrostatic capacity between the electrodes. This sensor also employs electrodes and should equip wiring, which gives rise to durability problems as same with Patent Literature 1. It is also difficult to prevent a sensation of a foreign object.

JP 2007-212196 A (Patent Literature 3) discloses a load detection device for a vehicle seat, which comprises a magnetism generator, equipped with a displaceable flexible element, and a magnetic sensor, equipped with a fixing element of a flame, having a magnetic impedance element that detects a magnetic field generated by the magnetism generator. Since the magnetism generator includes a magnet having a specified size in this device, it is quite difficult to dispose the magnetism generator near a surface of a cushion material without any foreign object sensation. In order to avoid the foreign object sensation, it is considered that the magnetism generator is disposed inside the cushion material, but this leads to the deterioration of detection accuracy.

JP 2006-014756 A (Patent Literature 4) discloses a biosignal detection device which comprises a permanent magnet and a magnetic sensor. Since the device also employs the permanent magnet which would give a foreign object sensation, it is difficult to place the device near a surface of the cushion material. The displacement of the device inside the cushion material leads to the deterioration of detection accuracy.

### CITATION LIST

### Patent Literature

### [PTL 1] JP 2012-108113 A

### [PTL 1] JP 2011-255743 A

### [PTL 1] JP 2007-212196 A

### [PTL 1] JP 2006-014756 A

### SUMMARY OF INVENTION

### Technical Problem

The present invention is to provide a deformation detection system which enhances durability of cushion pad without feeling of foreign object. As the results of the intense study to achieve the above object, the present inventors have found that a matrix layer in which electroconductive or magnetic filler is dispersed is used and is combined with a soft polyurethane foam, whereby adhesion properties between the matrix layer and the soft polyurethane foam is enhanced and the sitting of the person is detected by the displacements of the electroconductive or magnetic filler present in the matrix layer, thus the present invention having being accomplished.

### Solution to Problem

Accordingly, the present invention provides a system for detecting a deformation of a cushion pad, comprising;

the cushion pad comprising a matrix layer, in which electroconductive or magnetic filler is dispersed, and a soft polyurethane foam including the matrix layer incorporated therein, and

a detecting portion that detects an electric or magnetic change caused by a deformation of the cushion pad,

wherein the matrix layer has a hardness lower than the soft polyurethane.

The present invention also provides a method for producing a system for detecting a deformation of a cushion pad, which comprises the steps of:

a step of dispersing electroconductive or magnetic filler in polyurethane precursor solution,

a step of curing the polyurethane precursor solution to form a matrix layer in which the electroconductive or magnetic filler is dispersed,

a step of placing the matrix layer in a mold for the cushion pad,

a step of pouring a raw material of a soft polyurethane foam into the mold

a step of foaming the soft polyurethane foam raw material to form a cushion pad, and

a step of combining the cushion pad with a detecting portion that detects an electric or magnetic change caused by a deformation of the cushion pad,

wherein the matrix layer has a hardness lower than the soft polyurethane.

It is preferred that the matrix layer is a foamed article containing air bubbles.

The matrix layer preferably has an air bubble content of 20 to 80% by volume.

The matrix layer preferably has an average air bubble diameter of 50 to 300 μm.

In addition, it is preferred that the matrix layer has an average air bubble opening diameter of 15 to 100 μm.

The matrix layer more preferably has an independent air bubble ratio of 5 to 70%.

In addition, the cushion pad is used for seats and the deformation to be determined is caused by a sitting of a person.

### Advantageous Effects of Invention

According to the present invention, since the matrix layer in which the electroconductive or magnetic filler is dispersed is employed, it can hardly provide a foreign object sensation and would give comfortable feeling when a person sitting thereon, in comparison with that using a solid magnet or electrode. In addition, when the electroconductive filler is employed, the presence of the electroconductive filler forms conductive paths in the matrix layer, but the electric resistance of the conductive paths changes by the deformation of the matrix layer and the change of the electric resistance is detected. In order to measure the electric resistance of the matrix layer, it is necessary that a pair of electrodes is necessary. If the electrodes to be employed are made thin, then the electrodes would not provide solid feeling so much to the person sitting, thus improving sit feeling. When the magnetic sensor is employed, as the magnetic sensor detects a magnetic change caused by the magnetic filler contained in the magnetic elastomer, the magnetic sensor can be disposed separately with a certain distance apart from the magnetic elastomer and can be placed without wiring to connect with an electrode, which does not provide any problems, such as cutting wire or poor durability. Further, since wiring to connect with an electrode is not necessary, it is not needed to place any foreign object in the cushion pad and a production thereof would become easily.

The matrix layer of the present invention has a hardness smaller than the soft polyurethane foam. Based on the softer hardness, the matrix layer naturally is deformed following to the deformation of the cushion pad and does not generate a phenomenon of the peeling or separation of the matrix layer which generally occurs when a hard layer is present in a soft material, thus highly enhancing durability. In addition, in the case where the matrix layer is foamed, air bubble content, average air bubble diameter and independent bubble ratio of the matrix layer are controlled to enhance anchor effects and to enhance interface strength, thus preventing peeling the matrix layer off, because the raw solution of the polyurethane foam is wrapped around the matrix layer when forming the soft polyurethane foam. In the present invention, since the soft polyurethane foam is strongly adhered to the matrix layer, the matrix layer is hardly peeled off from the cushion pad and shows excellent durability. The resulted cushion pad is soft and comfortable when a person sitting thereon, because the matrix layer has elasticity.

### BRIEF DESCRIPTION OF DRAWINGS

FIG. 1 is a schematic sectional view which shows an embodiment that the system for detecting the deformation of the cushion pad using magnetic filler is applied to a seat for a vehicle.

FIG. 2 is a schematic view which shows the function or action of the matrix layer of the present invention which employs magnetic filler.

FIG. 3 shows a schematic perspective view of the cushion pad using magnetic filler of the present invention.

FIG. 4 shows a schematic perspective view of the cushion pad using electroconductive filler of the present invention.

### DESCRIPTION OF EMBODIMENTS

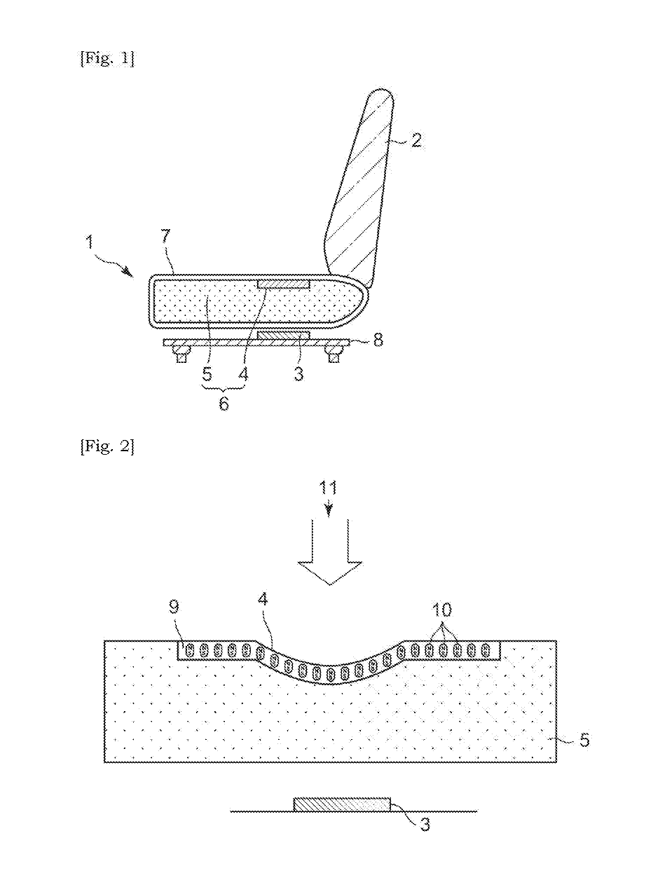

The present invention will be explained in detail by referring FIGS. 1 to 4. FIGS. 1 to 3 are related to an embodiment using magnetic filler and FIG. 4 is related to an embodiment using electroconductive filler.

FIG. 1 is a schematic sectional view which shows an embodiment that the system for detecting the deformation of the cushion pad using magnetic filler is applied to a seat for a vehicle.

The system of the present invention is basically composed of a sitting portion 1, a backrest portion 2 and a detecting portion 3 detecting magnetic change. The sitting portion 1 is a cushion pad 6 which comprises a matrix layer 4 and a soft polyurethane foam 5, and an outer skin covering the cushion pad 6. The matrix layer is disposed in layer in a portion of the sitting surface of the soft polyurethane foam 5. In the present invention, the matrix layer 4 is softer than the soft polyurethane foam 5 in hardness so as to follow the movement of the cushion pad and is hardly peeled off from the soft polyurethane foam 5, thus enhancing the durability of the cushion pad. In particular, in the case where the matrix layer is foamed, as the matrix layer is controlled to have a desired range of air bubble content, average air bubble opening diameter and independent air bubble content, a raw solution of the polyurethane foam is wrapped around the matrix layer or penetrated into the voids or air bubbles of the matrix layer and cured to highly enhance the adhesion between the soft polyurethane foam 5 and the matrix layer 4 in addition to physical anchor effects, when a soft polyurethane is prepared. The detecting portion 3 which detects magnetic changes is considered to be a magnetic sensor and it is preferred that the detecting portion is fixed to a pedestal 8 supporting the system. The pedestal 8 is fixed to a car body in the case of a car, which is not shown in the figures.

The hardness of the matrix layer and the soft polyurethane foam can generally be JIS-C hardness which is used for measuring a resin foam or soft resin, and can be measured according to JIS K-7312. The method for determining the hardness is concretely described in Examples of the present specification. The hardness can be determined by any hardness other than JIS-C hardness, as long as it can clearly show a hardness difference between the matrix layer and the soft polyurethane foam. In the case where the soft polyurethane foam has a JIC-C hardness of 30 to 60, the matrix layer should preferably have a JIS-C hardness slightly smaller than the soft polyurethane foam, for example JIS-C hardness of 1 to 59. A difference of the JIS-C hardnesses between them would preferably be about 0.1 to 50, but the difference is not limited to the range.

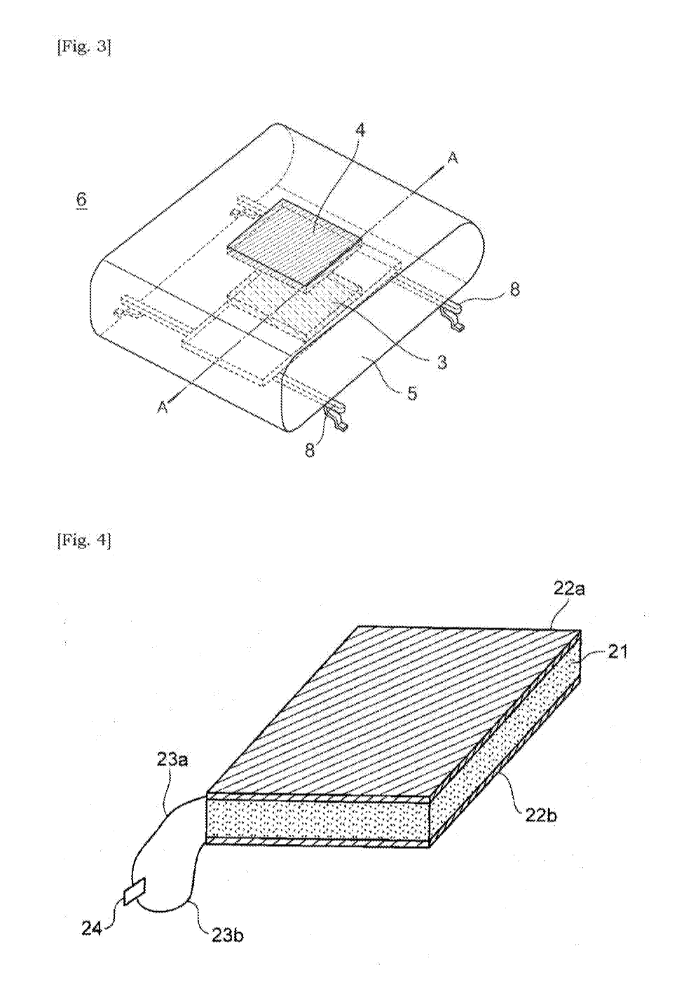

FIG. 3 shows a schematic perspective view of the cushion pad using magnetic filler of the present invention. FIG. 3 shows a perspective view of the cushion pad 6 which comprises the matrix layer 4 and the soft polyurethane foam 5, and it further shows the pedestal 8 and the detecting portion 3 mounting on the pedestal 8. FIG. 2 schematically shows an embodiment when the A-A line in FIG. 3 is vertically cut. The matrix layer 4 is disposed on an uppermost portion of the polyurethane foam, which can highly receive the deformation of the cushion when a person is sitting on the seat. FIG. 3 does not show the outer skin 7 which is present on the cushion pad 6. The outer skin 7 is generally made of leather, fabric, synthetic resin or the like, which is not limited thereto.

The matrix layer 4 contains many particles of the magnetic filler 10 in the matrix 9, as shown in FIG. 2.

FIG. 2 is a schematic view which shows the function or action of the matrix layer of the present invention. FIG. 2 shows an embodiment where the filler is the magnetic filler 10 and shows the matrix layer 4, the soft polyurethane foam 5 and the detecting portion (in this embodiment, magnetic sensor) 3, which are picked up for explaining their function. In FIG. 2, a pressure 11 is downwardly applied on the matrix layer 9. The matrix layer 9 is deformed by the pressure 11 and the magnetic filler 10 present in the portion where the pressure 11 is applied is downwardly lowered. The downward change of the magnetic filler 10 makes a magnetic field changed, which can be detected by the detecting portion 3.

The higher the pressure 11, the bigger the position change of the magnetic filler 10. The lower the pressure 11, the smaller the position change of the magnetic filler 10. The magnetic change by the position change would also show the strength of the pressure 11 which is also detectable. In FIGS. 1 to 3, number of the detecting portion 3 is only one, but number of the detecting portion 3 and its position can be changeable.

In FIG. 2, the magnetic filler 10 is employed. The magnetic filler generally includes rare earth-based, iron-based, cobalt based, nickel-based or oxide-based filler, which can be used in the present invention. The rare earth-based magnetic filler is preferred because it shows high magnetism, but is not limited thereto. Neodymium-based magnetic filler or samarium-based magnetic filler is more preferred. A shape of the magnetic filler 10 is not limited, but includes spherical, flake, needle, columnar or indefinite shape. The magnetic filler may preferably have an average particle size of 0.02 to 500 μm, preferably 0.1 to 400 μm, more preferably 0.5 to 300 μm. If it has an average particle size of less than 0.02 μm, the magnetic properties of the magnetic filler would become poor and if it has an average particle size of more than 500 μm, the mechanical properties (e.g. brittleness) of the magnetic elastomer would become poor.

The magnetic filler 10 may be introduced into the matrix layer after it is magnetized, but it is preferred that the magnetic filler is magnetized after it is introduced into the matrix layer, because the polarity of the magnetic filler can be easily controlled as shown in FIG. 2 and the detection of magnetism can be easily carried out.

The matrix layer 4 can be made from an elastomer, but preferred is thermosetting elastomer if properties, such as compression permanent strain and the like, are taken into consideration. The matrix layer 4 may be a molded article from a resin, but it can preferably be a foamed article in view of hardness, followability and the like.

The matrix layer 4 can preferably be made from polyurethane elastomer or silicone elastomer. When it is made from polyurethane elastomer, an active hydrogen-containing compound is mixed with the filler and then an isocyanate compound and if necessary a catalyst are mixed thereto to form a mixture solution. It is also conducted by mixing the filler and if necessary a catalyst with the isocyanate compound, into which the active hydrogen-containing compound is mixed, to obtain a mixture solution. The mixture solution is poured into a mold which has been treated with a mold releasing agent and heated to a curing temperature to cure, thus obtaining the matrix layer. When it is silicone elastomer, a precursor of the silicone elastomer is mixed with the filler and heated to cure, thus obtaining the elastomer. When forming the mixture solution, a solvent can be added thereto, if necessary. When the matrix layer 4 is made to be a foamed article, air may be taken in the mixture, when mixing, or a foam stabilizer or a foaming agent may also be formulated in the mixture. It may also be conducted by both the air mixing and the foam stabilizer or the foaming agent.

In this context, the isocyanate component and the active hydrogen-containing component to be employed for the polyurethane elastomer are listed hereinafter.

The isocyanate component is not limited and can be any one that has been employed in the field of polyurethane. Examples of the isocyanate components are an aromatic diisocyanate, such as 2,4-toluene diisocyanate, 2,6-toluene diisocyanate, 2,2′-diphenylmethane diisocyanate, 2,4′-diphenylmethane diisocyanate, 4,4′-diphenylmethane diisocyanate, 1,5-naphthalene diisocyanate, p-phenylene diisocyanate, m-phenylene diisocyanate, p-xylylene diisocyanate, and m-xylylene diisocyanate; an aliphatic diisocyanate, such as ethylene diisocyanate, 2,2,4-trimethylhexamethylene diisocyanate, and 1,6-hexamethylene diisocyanate; an alicyclic diisocyanate, such as 1,4-cyclohexane diisocyanate, 4,4′-dicyclohexylmethane diisocyanate, isophorone diisocyanate, and norbornane diisocyanate. The compounds can be used alone or in combination of two or more compounds thereof. In addition, the isocyanate can be modified by urethane modification, allophanate modification, biuret modification, isocyanulate modification or the like.

The active hydrogen-containing compound can be any one that has been employed in the field of polyurethane. Examples of the active hydrogen-containing compounds are a polyether polyol, such as polytetramethylene glycol, polypropylene glycol, polyethylene glycol and a copolymer of polypropylene oxide and polyethylene oxide; a polyester polyol, such as polybutylene adipate, polyethylene adipate, and 3-methyl-1,5-pentane adipate; a polyester polycarbonate polyol, such as a reaction product of a polyester glycol (e.g. polycaprolactone polyol and polycaprolactone) and an alkylene carbonate; a polyester polycarbonate polyol obtained by reacting ethylene carbonate with a polyhydric alcohol to form a reaction mixture, followed by reacting the reaction mixture with an organic dicarboxylic acid; a polycarbonate polyol obtained by ester-exchange reacting a polyhydroxyl compound with an aryl carbonate; and the like. The active hydrogen-containing compounds can be used alone or a combination of two or more compounds thereof.

In addition to the above-mentioned high molecular weight polyol component, the active hydrogen-containing component can also include a low molecular weight polyol, such as ethylene glycol, 1,2-propylene glycol, 1,3-propylene glycol, 1,4-butanediol, 1,6-hexanediol, neopentyl glycol, 1,4-cyclohexane dimethanol, 3-methyl-1,5-pentanediol, diethylene glycol, triethylene glycol, 1,4-bis(2-hydroxyethoxy)benzene, trimethylolpropane, glycerin, 1,2,6-hexane triol, pentaerythritol, tetramethylol cyclohexane, methyl glucoside, sorbitol, mannitol, dulcitol, sucrose, 2,2,6,6-tetrakis(hydroxymethyl)cyclohexanol, and triethanolamine; and a low molecular weight polyamine, such as ethylenediamine, tolylenediamine, diphenylmethanediamine, diethylenetriamine and the like. These compounds can be used alone or a combination of two or more compounds thereof. A polyamine, including 4,4′-methylenebis(o-chloroaniline)(MOCA), 2,6-dichloro-p-phenylenediamine, 4,4′-methylenebis(2,3-dichloroaniline), 3,5-bis(methylthio)-2,4-toluenediamine, 3,5-bis(methylthio)-2,6-toluenediamine, 3,5-diethyltoluene-2,4-diamine, 3,5-diethyltoluene-2,6-diamine, trimethyleneglycol-di-p-aminobenzoate, polytetramethyleneoxide-di-p-aminobenzoate, 1,2-bis(2-aminophenylthio)ethane, 4,4′-diamino-3,3′-diethyl-5,5′-dimethyldiphenylmethane, N,N′-di-sec-butyl-4,4′-diaminodiphenylmethane, 4,4′-diamino-3,3′-diethyldiphenylmethane, 4,4′-diamino-3,3′-diethyl-5,5′-dimethyldiphenylmethane, 4,4′-diamino-3,3′-diisopropyl-5,5′-dimethyldiphenylmethane, 4,4′-diamino-3,3′,5,5′-tetraethyldiphenylmethane, m-xylylenediamine, N,N′-di-sec-butyl-p-phenylenediamine, m-phenylenediamine, p-xylylenediamine; and the like, may also be added thereto.

The catalyst can be any one which has been known to the art and examples of it may include a tertiary amine catalyst, such as triethylenediamine (1,4-diazabicyclo-[2,2,2] octane), N,N,N′,N′,-tetramethylhexadiamine, bis-(2-dimethylaminoethyl ether; a metal catalyst, such as tin octylate, lead octylate, zinc octylate, bismuth octylate; and the like. The catalyst can be used alone or a combination of two or more thereof. The catalyst can be commercially available and examples of them include “TEDA-L33” available from Tosoh Corporation, “NIAX CATALYST A1” available from Momentive Performance Materials Japan LLC, “Kao Rizer No. 1” or “Kao Rizer No. 30P” available from Kao Corporation, “DABCO T-9” available from Air Products Co., Ltd., “BTT-24” available from Toei Chemical Industry Co., Ltd., “PUCAT 25” available from Nihon Kagaku Sangyo Co., Ltd., and the like.

★★ [symbol] [symbol] [symbol] [symbol] [symbol] ?★★

The foam stabilizer of the present invention can be any one that has been employed for conventional polyurethane resin foam, including silicone type foam stabilizer, fluorine type foam stabilizer and the like. A silicone type surfactant or a fluorine type surfactant, which is employed for the silicone type foam stabilizer or fluorine type foam stabilizer, has both a portion soluble to the polyurethane and a portion insoluble to the polyurethane, of which the polyurethane-insoluble portion lowers a surface tension of the polyurethane to easily generate air bubbles and to effectively prevent breaking the air bubbles. Commercially available silicone type foam stabilizers include “SF-2962”, “SRX 274DL”, “SF-2965”, “SF-2904”, “SF-2908”, “SF2904” and “L5340” manufactured from Dow Corning Toray Co., Ltd.; “Tegostab R B8017”, “B-8465” and “B-8443” manufactured from Evonik Japan Co., Ltd.; and the like. Commercially available fluorine type foam stabilizers include “FC430” and “FC4430” obtained from Sumitomo 3M Co., Ltd.; “FC142D”, “F552”, “F554”, “F558”, “F561” and “R41” obtained from DIC Corporation; and the like. An amount of the foam stabilizer may preferably be 1 to 15 parts by weight, more preferably 2 to 12 parts by weight, based on 100 parts by weight of the resin content. Amounts of less than 1 part by weight of the foam stabilizer do not provide sufficient foaming and those of more than 15 parts by weight have a possibility of bleed out.

An amount of the electroconductive or magnetic filler in the matrix layer can preferably be 1 to 450 parts by weight, more preferably 2 to 400 parts by weight, based on 100 parts by weigh of the matrix layer. Amounts of less than 1 part by weight make it difficult to detect electric and magnetic changes and those of more than 450 parts by weight make the matrix layer brittle and cannot obtain the desired properties.

In the present invention, a peripheral portion of the matrix layer may be sealed by a sealing material as long as it does not deteriorate the flexibility of the matrix layer. The sealing material can be thermoplastic resin, thermosetting resin or a mixture thereof. The thermoplastic resin includes styrene based thermoplastic elastomer, polyolefin based thermoplastic elastomer, polyurethane based thermoplastic elastomer, polyester based thermoplastic elastomer, polyamide based thermoplastic elastomer, polybutadiene based thermoplastic elastomer, polyisoprene based thermoplastic elastomer, fluoride based thermoplastic elastomer, ethylene ethylacrylate copolymer, ethylene vinylacetate copolymer, polyvinylchloride, polyvinylidene chloride, chlorinated polyethylene, fluoride resin, polyamide, polyethylene, polypropylene, polyethylene terephthalate, polybutylene terephthalate, polystyrene, polybutadiene or the like. The thermosetting resin includes, for example, diene based synthetic rubber, such as polyisoprene rubber, polybutadine rubber, styrene-butadiene rubber, polychloroprene rubber and acrylonitrile butadiene rubber; non-diene based rubber, such as ethylene-propylene rubber, ethylene-propylene-diene rubber, butyl rubber, acryl rubber, polyurethane rubber, fluororubber, silicone rubber and epichlorohydrine rubber; natural rubber; polyurethane resin; silicone resin; epoxy resin; or the like. When the sealing material is thermoplastic resin, thermosetting resin or a mixture thereof, it can be used in the form of film. The sealing material may be formed by adhering with heat fusion or by adhering with adhesion agent. The sealing material may be formed into a paint and may be coated on the matrix layer.

FIG. 4 shows a schematic perspective view of the matrix layer 21 using electroconductive filler of the present invention. In this case, a pair of thin electrode layers (22a and 22b) is disposed on an upside and a downside of the matrix layer 21 so that the matrix can be bent. The matrix layer 21 includes the electroconductive filler. The electrode layers (22a and 22b) may be made by vapor deposition of conductive metal (such as gold) to form a thin electrode layer. Lead wires (23a and 23b) are extended from the electrode layers (22a and 22b) and connected with a resistance measurement device 24 to determine a resistance value of the matrix layer 21. The resistance measurement device can be any one that generally has been used. The matrix layer 21 is shown as a flat rectangular shape in FIG. 4, but is not limited thereto. The electrodes are also formed overall the upper and lower sides of the matrix layer 21 as shown by 22a and 22b in FIG. 4, but are not limited thereto. In FIG. 4, the resistance measurement device 24 is described as being present beside the matrix layer 21, but it is not necessary to be at the position. The resistance measurement device 24 may be positioned such that the cushion characteristics of the matrix layer and the soft polyurethane foam are not deteriorated.

The matrix layer 21 of the embodiment shown in FIG. 4 can also be an elastomer, and preferred one is thermosetting elastomer. More preferred one can be polyurethane elastomer or silicone elastomer as explained in the above FIGS. 1 to 3.

The electroconductive filler is not limited and can be any one that has electroconductivity. The electroconductive filler includes small particles made of carbon material, metal and the like. The electroconductive filler preferably has an aspect ratio (a ratio of long side based on short side) of 1 to 2. If the aspect ratio is larger than 2, since the particles of the conductive filler are easily connected to the other particles, electric conductive paths are formed easily, but a desired change of an electric resistance caused by the deformation of the matrix layer cannot be obtained easily. The electroconductive filler may preferably be in the shape of sphere and it may more preferably be spherical silver particles.

In the present invention, the matrix layer may either be foamed or not foamed, but it is preferably foamed because the foamed matrix layer has roughness on an adhered surface of the matrix layer to the soft polyurethane foam, which generates anchor effects by the raw solution of the polyurethane foam wrapping around the matrix layer. When the matrix layer is foamed, it is preferred that the matrix layer has an air bubble content of 20 to 80% by volume. The air bubble content can more preferably be 20 to 70% by volume. If the air bubble content is less than 20% by volume, the interfacial anchor effects with the soft polyurethane foam would be deteriorated and durability would also be reduced. If it is more than 80% by volume, the foamed article containing electroconductive or magnetic filler is brittle and poor in handling properties. The air bubble content can be obtained by measuring a specific gravity according to JIS Z-8807-1976 and then calculating from the measured specific gravity and the specific gravity of a non-foamed article. The measurement of the specific gravity can be conducted by placing a sample for measuring, which is obtained by cutting the magnetic polyurethane foam into a size of 40 mm×74 mm, in a circumstance of a temperature of 23±2° C. and a humidity of 50±5% for 16 hours and determining a specific gravity using a gravimeter available from Sartorius Japan K.K. as LA-230S.

When the matrix layer is foamed in the present invention, it is preferred that the matrix layer has an average air bubble diameter of 50 to 300 μm. In the case where the average air bubble diameter is within the above range, the raw solution of the soft polyurethane foam is sufficiently wrapped around the matrix layer and the soft polyurethane foam is strongly adhered with the matrix layer. This makes it possible to produce a cushion pad having strong interfacial strength and makes difficult peeling of the matrix layer from the cushion pad, thus enhancing the durability. The matrix layer more preferably has an average air bubble diameter of 70 to 270 μm. Average air bubble diameters of less than 50 μm deteriorate property stabilities because of low strengthen effects and those of more than 300 μm also deteriorate property stabilities because of small surface areas and lower interfacial strengthen effects.

In addition, when the matrix layer of the present invention is in the form of a foamed article, it is preferred that the matrix layer has an average air bubble opening diameter of 15 to 100 μm. In the case where the average air bubble opening diameter is within the above range, the raw solution of the soft polyurethane foam is sufficiently wrapped around the matrix layer and the soft polyurethane foam is strongly adhered with the matrix layer. This makes it possible to produce a cushion pad having strong interfacial strength and makes difficult peeling of the matrix layer from the cushion pad, thus enhancing the durability. The matrix layer more preferably has an average air bubble opening diameter of 20 to 80 μm. Average air bubble opening diameters of less than 15 μm deteriorate property stabilities because of low strengthen effects and those of more than 20 μm also deteriorate property stabilities because of small surface areas and lower interfacial strengthen effects.

The average air bubble diameter and the average air bubble opening diameter can be determined as follow: A cross section of the produced matrix layer is observed by a scanning electron microscope (SEM) (available from Hitachi Science System Co., Ltd. as 3500N) with 100 times to obtain an image, and any air bubble diameter and any air bubble opening diameter of the obtained image is measured by an image analyze soft (available from Mitani Corporation as WinROOF) to calculate an average air bubble diameter and an average air bubble opening diameter.

When the matrix layer of the present invention is in the form of a foamed article, it is preferred that the matrix layer has an independent air bubble ratio of 5 to 70%. If the independent air bubble ratio is too high, the wrapping around of the raw solution of the soft polyurethane foam reduces and strong adhesion is not obtained. The independent air bubble ratio is more preferably within the range of 5 to 65%. Independent air bubble ratios of less than 5% deteriorate property stabilities because of ununiform of the wrapping around of the raw solution of the soft polyurethane foam to the matrix layer, and those of more than 70% also deteriorate the adhesion power between the matrix layer and the soft polyurethane foam because of poor wrapping of the raw solution of the soft polyurethane foam to the matrix layer. The independent air bubble ratio can be calculated by the following equation:

Independent air bubble ratio (%)=100−Interconnected bubble ratio (%)

In the above equation, the interconnected bubble ratio is determined according to ASTM-2856-94-C method. A measuring apparatus can be an air comparison expression specific gravity meter 930 type (available from Beckman Company) using a sample size of 20 mm×20 mm. The interconnected bubble ratio can be calculated from the following equation:

Interconnected bubble ratio=[(V−V1)/V]×100

V: Apparent volume calculated from the sample size (cm³)

V1: Volume of sample measured by the air comparison expression specific gravity meter (cm³).

In FIGS. 1 to 3, the detecting portion 3 can be a magnetic sensor and, in FIG. 4 using electroconductive filler, it can be a device detecting changes of electric resistance. The magnetic sensor can be any one that has generally been used for detecting magnetism. It may include a magnetoresistive element (e.g. a semiconductor magnetoresistive element, an anisotropic magnetoresistive element (AMR), a gigantic magnetoresistive element (GMR) or a tunnel magnetoresistive element (TMR)), a hall element, an inductor, an MI element, a flux gate sensor and the like. The hall element is preferred because it can cover in a wide range with high sensitivity. The device for measuring changes of electric resistance can be a digital multi-meter.

Process for Producing the System

The present invention provides a method for producing a system for detecting a deformation of a cushion pad, which comprises the steps of:

a step of dispersing electroconductive or magnetic filler in polyurethane precursor solution,

a step of curing the polyurethane precursor solution to form a matrix layer in which the electroconductive or magnetic filler is dispersed,

a step of placing the matrix layer in a mold for the cushion pad,

a step of pouring a raw material of a soft polyurethane foam into the mold

a step of foaming the soft polyurethane foam raw material to form a cushion pad, and

a step of combining the cushion pad with a detecting portion that detects an electric or magnetic change caused by a deformation of the cushion pad,

wherein the matrix layer has a hardness lower than the soft polyurethane.

The matrix layer can be prepared by formulating the electroconductive or magnetic filler when forming elastomer and then reacting in the mold. When the matrix layer is a foamed article, it can be foamed using a foam stabilizer or a foaming agent or can be mixed by taking air to form a foamed article, or the both can employed.

The resultant matrix layer is disposed in the mold for the cushion pad, into which a raw solution for the soft polyurethane foam is poured. The raw solution of the soft polyurethane foam is foamed to form a cushion pad, wherein the raw solution of the soft polyurethane foam is adhered to the matrix layer. In the case where the matrix layer is a foamed article, the raw solution of the soft polyurethane foam is wrapped around the matrix layer and then foamed and cured, and therefore the soft polyurethane foam which has wrapped the matrix layer provides anchor effects and the two foamed articles are suitably integrated, thus enhancing durability and improving adhesion so as not to peel the matrix layer off. In the case where the matrix layer is not a foamed article, the matrix layer may be treated with sand paper to form uneven surface, in order to enhance the adhesion power between the soft polyurethane foam and the matrix layer.

The raw solution of the soft polyurethane foam comprises a polyisocyanate component and an active hydrogen-containing compound (such as a polyol, water or the like). Examples of the polyisocyanate components and the active hydrogen-containing compounds are listed hereinafter.

The polyisocyanate component can be any one that has been used in the field of polyurethane. Examples of the polyisocyanate components are an aromatic diisocyanate, such as 2,4-toluene diisocyanate, 2,6-toluene diisocyanate, 2,2′-diphenylmethane diisocyanate, 2,4′-diphenylmethane diisocyanate, 4,4′-diphenylmethane diisocyanate, 1,5-naphthalene diisocyanate, p-phenylene diisocyanate, m-phenylene diisocyanate, p-xylylene diisocyanate, m-xylylene diisocyanate and the like. It can also be polynuclear compounds of diphenylmethane diisocyanate (crude MDI). The polyisocyanate compound can further be an aliphatic diisocyanate, such as ethylene diisocyanate, 2,2,4-trimethylhexamethylene diisocyanate and 1,6-hexamethylene diisocyanate; an alicyclic diisocyanate, such as 1,4-cyclohexane diisocyanate, 4,4′-dicyclohexylmethane diisocyanate, isophorone diisocyanate, norbornane diisocyanate; and the like. These can be used alone or in combination with two or more isocyanates thereof. In addition, the isocyanate can be modified by urethane modification, allophanate modification, biuret modification, isocyanulate modification or the like.

The active hydrogen-containing compound can be any one that has generally been used in the field of polyurethane. Examples of the active hydrogen-containing compounds are a polyether polyol, such as polytetramethylene ether glycol, polypropylene glycol, polyethylene glycol and a copolymer of propylene oxide and ethylene oxide; a polyester polyol, such as polybutylene adipate, polyethylene adipate, and 3-methyl-1,5-pentane adipate; a polyester polycarbonate polyol, such as a reaction product of polyester glycol (e.g. polycaprolactone polyol or polycaprolactone) and alkylene carbonate; a polyester polycarbonate polyol obtained by reacting polyethylene carbonate with a polyhydric alcohol to form a reaction mixture, followed by reacting the reaction mixture with an organic dicarboxylic acid; a polycarbonate polyol obtained by ester-exchange reacting a polyhydroxyl compound with an aryl carbonate; and the like. The active hydrogen-containing compounds can be used alone or a combination of two or more compounds thereof. The concrete examples of the active hydrogen-containing compounds include, for example EP 3028, EP 3033, EP 828, POP 3128, POP 3428 and POP 3628, commercially available from Mitsui Chemical Inc.; and the like.

When producing the soft polyurethane foam, other components, such as crosslinking agent, foam stabilizer, catalyst and the like can be employed and they are not limited thereto. Since the soft polyurethane foam is a foamed article, it has values of air bubble content, average air bubble diameter and the like as the matrix layer. The air bubbles of the soft polyurethane foam, however, are very large apart from the matrix layer and it is not necessary to define the air bubble content and the like.

The crosslinking agent may include triethanolamine, diethanolamine or the like. The foam stabilizer may include SF-2962, SRX-274C, 2969T and the like, available from Dow Corning Toray Co., Ltd. Examples of the catalysts are Dabco 33LV available from Air Products Japan Co., Ltd., Toyocat ET, SPF2, MR available from Tosoh Corporation, and like.

In addition, an additive, such as water, toner, flame retardant or the like can be suitably employed if necessary.

Examples of the flame retardants are CR 530 or CR 505 available from Daihachi Chemical Industry Co., Ltd.

The cushion pad obtained by the above method, is combined with a detecting portion detecting electric changes or magnetic changes to obtain a system for detecting a deformation of cushion pad according to the present invention. The detecting portion for detecting electric changes can be digital multi-meter and that for detecting magnetic changes can be a magnetic sensor.

### EXAMPLES

The present invention is further explained based on the following examples which, however, are not construed as limiting the present invention to their details.

### Preparation Example 1 Synthesis of Prepolymer A Having Terminal Isocyanate Group

A reaction vessel was charged with 42.6 parts by weight of polyol A (3-methyl-1,5-pentane adipate, OH value 56 and functionality 2, available from Kuraray Co., Ltd. as P-2010) and 42.6 parts by weight of polyol B (polyester polyol obtained from 3-methyl-1,5-pentane diol, trimethylolpropane and adipic acid, OH value 56, functionality 3, available from Kuraray Co., Ltd. as F-3010) and dehydrated at a reduced pressure with stirring for one hour. The reaction vessel was then changed to nitrogen atmosphere. Next, 14.8 parts by weight of toluene diisocyanate (2,4 configuration=80%, available from Mitsui Chemicals Inc. as Cosmonate T-80) was added to the reaction vessel and reacted for 2 hours at a temperature of 80° C. in the reaction vessel to synthesize a prepolymer A having a terminal isocyanate group (NCO %=3.58%).

### Example 1

Next, a mixture solution of 43.8 parts by weight of polyol B, 4.8 parts by weight of silicone type foam stabilizer (available from Toray Dow Corning Co., Ltd. as L-5340), 0.12 parts by weight of lead octylate (BTT-24 available from Toey Chemical Industry Co., Ltd.) was mixed with 81.0 parts by weight of neodymium based filler (MF-15P available from Aichi Steel Corporation, average particle size=33 μm) to form a filler dispersion. The filler dispersion was vigorously mixed for 5 minutes using a mixing impeller at a revolution number of 1,000 rpm (first mixing), so as to take air bubbles in the reaction system. Thereafter, 51.4 parts by weight of the prepolymer A obtained above was added thereto and mixed for 3 minutes (second mixing) to obtain an air bubble-dispersed urethane composition containing magnetic filler. The urethane composition was added dropwise on a PET film which had been treated with a mold releasing agent and also contains a spacer of 1.0 mm, and then the thickness of the urethane resin was adjusted by a nip roller to a 1.0 mm thickness. It was then kept at 80° C. for 1 hour to cure, thus obtaining a magnetic filler dispersed polyurethane foam. The resulting foam was then magnetized at 2.0 T using a magnetizing apparatus (available from Denshijiki Industry Co., Ltd.) to obtain a magnetic matrix layer.

The resultant matrix layer was subjected to the evaluation of JIS-C hardness, air bubble content, average air bubble diameter, average air babble opening diameter and independent air bubble ratio according to the following measuring methods. The evaluated values are listed in Table 1, together with formulation of matrix layer, filler content (volume %), first mixing time period (minutes) and second mixing time period (minutes), both time periods being for production conditions.

Evaluation of JIS-C Hardness

The hardness was determined according to JIS K-7312. The produced matrix layer was cut into a size of 50 mm×50 mm as a sample for determination and was kept as it was at a temperature of 23±2° C. and a humidity of 50±5% for 16 hours. The samples were piled to form a thickness of 10 mm or more. It was determined by contacting a pressure surface of a hardness meter (available from Kobunshi Keiki Co., Ltd. as Asker C Type Hardness Meter, Height of pressure surface: 3 mm) and determining after 30 seconds contact.

Air Bubble Content

A specific gravity was determined according to JIS Z-8807-1976 and was combined with a specific gravity of a nonfoamed article to calculate into an air bubble content. The specific gravity was determined by cutting the produced matrix layer into a sample for determination of a size of 40 mm×75 mm and keeping it as it was at a temperature of 23±2° C. and a humidity of 50±5% for 16 hours, followed by measuring using a gravimeter available from Sartorius Japan K.K. as LA-230S.

Average Air Bubble Diameter and Average Air Bubble Opening Diameter

The produced elastomer was cut to obtain a sample, of which a cross section was observed by a scanning type electronic microscope (SEM; available from Hitachi Science Systems Co., Ltd. as S-3500N) with 100 times. From the resulting image, an air bubble diameter and an air bubble opening diameter in any areas were measured, using an image analysis software (WinRoof available from Mitani Corporation), to calculate an average air bubble diameter and an average air bubble opening diameter.

Independent Air Bubble Ratio

The independent air bubble ratio was calculated from the following equation:

Independent air bubble ratio (%)=100−Interconnected bubble ratio (%)

In the above equation, the interconnected bubble content is determined according to ASTM-2856-94-C method. A measuring apparatus employs an air comparison expression specific gravity meter 930 type (available from Beckman Company) using a sample cutting into a sample size of 20 mm×20 mm. The interconnected bubble ratio can be calculated from the following equation:

Interconnected bubble ratio=[(V−V1)/V]×100

V: Apparent volume calculated from the sample size (cm³)

V1: Volume of sample measured by the air comparison expression specific gravity meter (cm³).

Next, 60.0 parts by weight of a polypropylene glycol (available from Mitsui Chemicals Inc. as EP-3028; OH value 28), 40.0 parts by weight of a polymer polyol (available from Mitsui Chemicals Inc. as POP-3128; OH value 28), 2.0 parts by weight of diethanolamine (available from Mitsui Chemicals Inc.), 3.0 parts by weight of water, 1.0 part by weight of a foam stabilizer (available from Dow Corning Toray Co., Ltd. as SF-2962) and 0.5 parts by weight of an amine catalyst (available from Air Products Japan Co., Ltd. as Dabco 33LV) were mixed with stirring to obtain a mixture A which was controlled to a temperature of 23° C. Separately, a mixture of toluene diisocyanate and crude MDI (80/20 weight ratio; available from Mitsui Chemicals Inc. as TM-20; NCO %=44.8%) was controlled to a temperature of 23° C. to obtain a mixture B.

The matrix layer obtained above was cut to 50 mm square and was placed in a mold for cushion pad and heated to a mold temperature of 62° C. Into the mold, a raw material obtained by mixing the mixture A with the mixture B so as to become NCO index=1.0 was poured using a high pressure foaming machine and foamed and cured at a mold temperature 62° C. for 5 minutes to obtain a matrix layer-integrated cushion pad. The cushion pad was subjected to a determination of property stability (%), as explained hereinafter. The soft polyurethane foam was also subjected to a determination of JIS-C hardness which was determined as same with the JIS-C hardness determination of the matrix layer. The results are shown in Table 1.

Measurement of Property Stability

The resultant cushion pad was subjected to durability test of 500,000 times under a load of 500 N at a temperature of 40° C. and a humidity of 60% and the property stability was determined by a change rate of sensor performance against its initial value. The sensor performance was determined by a change rate of output voltage of a Hall element at the time of applying a pressure of 10 kPa, using a pressure indenter having 40 mmφ for applying pressures.

### Examples 2 to 11 and Comparative Examples 1 to 2

A matrix layer was prepared by using the formulation shown in Table 1 and a cushion pad was also obtained as generally described in Example 1. The resulting cushion pad was subjected to the evaluation of JIS-C hardness etc. and properties stability. The results are shown in Table 1. It is noted that, in Comparative Example 1, the matrix layer was not foamed and its JIS-C hardness was higher (harder) than the soft polyurethane foam, and that, in Comparative Example 2, the JIS-C hardness of the matrix layer was near that of the soft polyurethane foam, but a little higher (harder) than that.

In Example 9, the electroconductive filler (silver type filler) was formulated and the resulting electroconductive filler-containing-foamed resin (electroconductive resin) was cut into a size of 5 to 30 mm, the upper and lower surfaces of the resin of the resin being vapor deposited with gold by an ion sputtering device to form gold electrode layers. A lead wire was connected with the surfaces and the resulting resin was adhered to the cushion pad by double side adhesive tape, to form a matrix layer adhered cushion pad. The lead wire of the cushion pad was connected to a digital multimeter (available from Agilent Technologies Japan, Ltd. as Agilent 3410A) and subjected to the durability test. The properties of the sensor were obtained by an electric resistance change rate when a pressure of 10 kPa was applied.

TABLE 1

| | | | | | | | | | | | | Comparative | |
|---|---|---|---|---|---|---|---|---|---|---|---|---|---|
| | | | Examples | | | | | | | | | Examples | |
| | | | 1 | 2 | 3 | 4 | 5 | 6 | 7 | 8 | 9 | 1 | 2 |
| Formulation | Prepolymer | Prepolymer A | 51.4 | 51.4 | 51.4 | 49.1 | 52.4 | 51.4 | 51.4 | 41.3 | 51.4 | 54.0 | 45.1 |
| | Curing agent | Polyol B | 43.8 | 43.8 | 43.8 | 41.8 | 44.7 | 43.8 | 43.8 | 58.7 | 43.8 | 46.0 | 54.9 |
| | Filler content (vol %) | Neodium type | 81.0 | 186.2 | 48.4 | 321.1 | 45.3 | | | 36.8 | | 36.8 | 36.8 |
| | | Samarium type | | | | | | 180.4 | 47.8 | | | | |
| | | Silver type | | | | | | | | | 73.5 | | |
| | Catalyst | Lead octylate | 0.12 | 0.12 | 0.12 | 0.12 | 0.12 | 0.12 | 0.12 | 0.12 | 0.12 | 0.12 | 0.12 |
| | Foam stabilizer | L-5340 | 4.8 | 4.8 | 4.8 | 9.1 | 2.9 | 4.8 | 4.8 | 0.0 | 4.8 | 0.0 | 0.0 |

| | | | | | | | | | | | | |
|---|---|---|---|---|---|---|---|---|---|---|---|---|
| | NCO index | 1.00 | 1.00 | 1.00 | 1.00 | 1.00 | 1.00 | 1.00 | 0.60 | 1.00 | 1.00 | 0.70 |
| | Filler content (vol %) | 5.0 | 5.0 | 5.0 | 5.0 | 5.0 | 5.0 | 5.0 | 5.0 | 5.0 | 5.0 | 5.0 |
| Production | First mixing time period (min) | 5 | 10 | 3 | 15 | 3 | 10 | 3 | 0 | 5 | 0 | 0 |
| conditions | Second mixing time period (min) | 3 | 3 | 3 | 1 | 3 | 1 | 3 | 3 | 3 | 3 | 3 |
| Results | Hardness C(Filler dispersed matrix layer) | 16 | 9 | 24 | 3 | 29 | 11 | 28 | 27 | 29 | 68 | 34 |
| | Hardness C (Soft foamed polyurethane layer) | 32 | 32 | 32 | 32 | 32 | 32 | 32 | 32 | 32 | 32 | 32 |
| | Air bubble content (vol %) | 51.8 | 76.2 | 22.7 | 84.1 | 17.8 | 75.6 | 21.8 | 0.0 | 23.6 | 0.0 | 0.0 |
| | Average air bubble diameter (μm) | 142 | 264 | 84 | 365 | 41 | 324 | 48 | 0 | 56 | 0 | 0 |
| | Average air bubble opening diameter (μm) | 41 | 83 | 24 | 117 | 12 | 112 | 13 | 0 | 18 | 0 | 0 |
| | Independent air bubble diameter (%) | 25.4 | 7.9 | 64.1 | 3.2 | 72.1 | 5.9 | 73.6 | 0.0 | 67.2 | 0.0 | 0.0 |
| | Property stability (%) | 8.3 | 11.2 | 9.7 | 16.9 | 18.1 | 13.6 | 15.2 | 19.8 | 19.4 | 24.1 | 22.6 |

In Table 1, Samarium based filler is Sm—Fe—N alloy fine powder (average particle size 2.5 μm, available from Sumitomo Metal Mining Co., Ltd.

Silver filler is Ag-HWQ2.5 μm (average particle size 2.5 μm, available from Fukuda Metal Foil & Powder Co., Ltd.).

As is apparent from Table 1, the cushion pads of Examples of the present invention are excellent in property stability. However, in Comparative Examples 1 and 2 where the hardness (JIS-C hardness values) of the matrix layer is higher than that of the soft polyurethane foam, the property stability shows high and the output voltage change ratio is larger than the original point and the durability was poor.

In Examples 1 to 3 where the air bubble content, average air bubble diameter, average air babble opening diameter and independent air bubble ratio of the matrix layer are in the preferred ranges, the property stability is 11.2% or less and shows high stability. In Examples 4 and 5 where the air bubble content, average air bubble diameter, average air babble opening diameter and independent air bubble ratio of the matrix layer are not in the preferred ranges, the property stability is still high in comparison with Comparative Examples. In Example 6 where the average air bubble content and independent air bubble ratio are within the preferred range, but the average air bubble diameter and average air bubble opening diameter are not in the preferred range, the property stability is good. In Example 7 where the air bubble content is within the preferred range, but the other values are not in the preferred range, the property stability is in the allowable range. In Example 8 where the matrix layer is not foamed, the average air bubble diameter and average air bubble opening diameter are 0, but the property stability are rather good in comparison with Comparative Examples. In Example 9 where an electrode is formed on the foamed resin layer containing electroconductive filler, the property stability is better than those of Comparative Examples.

### INDUSTRIAL APPLICABILITY

The system for detecting a deformation of cushion pad of the present invention can be applied to a seat for a vehicle and is excellent in durability so that it endures a long period of use. In addition, the resulted cushion pad is soft and comfortable even a person sits a long period of time, because the matrix layer is employed.

### REFERENCE SIGNS LIST

1 Sitting portion
2 Backrest portion
3 Magnetic sensor
4 Matrix layer
5 Soft polyurethane foam
6 Cushion pad
7 Outer skin
8 Pedestal
9 Elastomer
10 Magnetic filler
11 Pressure
21 Matrix layer
22a and 22b Electrode
23a and 23b Lead wire
24 Resistance measuring device

1. A system for detecting a deformation of a cushion pad, comprising;
the cushion pad comprising a matrix layer, in which electroconductive or magnetic filler is dispersed, and a soft polyurethane foam including the matrix layer incorporated therein, and
a detecting portion that detects an electric or magnetic change caused by a deformation of the cushion pad,
wherein the matrix layer has a hardness lower than the soft polyurethane.

2. The system for detecting the deformation of the cushion pad according to claim 1, wherein the matrix layer is a foam article containing air bubbles.

3. The system for detecting the deformation of the cushion pad according to claim 2, wherein the matrix layer has an air bubble content of 20 to 80% by volume.

4. The system for detecting the deformation of the cushion pad according to claim 2, wherein the matrix layer has an average air babble diameter of 50 to 300 μm.

5. The system for detecting the deformation of the cushion pad according to claim 2, wherein the matrix layer has an average air bubble opening diameter of 15 to 100 μm.

6. The system for detecting the deformation of the cushion pad according to claim 2, wherein the matrix layer has an independent air bubble ratio of 5 to 70%.

7. The system for detecting the deformation of the cushion pad according to claim 1, wherein the cushion pad is for seats and the deformation to be detected is caused by a sitting of a person.

8. A method for producing a system for detecting a deformation of a cushion pad, which comprises the steps of:
a step of dispersing electroconductive or magnetic filler in polyurethane precursor solution,
a step of curing the polyurethane precursor solution to form a matrix layer in which the electroconductive or magnetic filler is dispersed,
a step of placing the matrix layer in a mold for the cushion pad,
a step of pouring a raw material of a soft polyurethane foam into the mold
a step of foaming the soft polyurethane foam raw material to form a cushion pad, and
a step of combining the cushion pad with a detecting portion that detects an electric or magnetic change caused by a deformation of the cushion pad,
wherein the matrix layer has a hardness lower than the soft polyurethane.

9. The method according to claim 8, wherein the matrix layer is a foamed article containing air bubbles.

10. The method according to claim 9, wherein the matrix layer has an air bubble content of 20 to 80% by volume.

11. The method according to claim 9, wherein the matrix layer has an average air babble diameter of 50 to 300 μm.

12. The method according to claim 9, wherein the matrix layer has an average air bubble opening diameter of 15 to 100 μm.

13. The method according to claim 9, wherein the matrix layer has an independent air bubble ratio of 5 to 70%.
